(19) United States
(12) Patent Application Publication
(10) Pub. No.: US 2021/0140512 A1
(43) Pub. Date: May 13, 2021

(54) METAL BELT MANUFACTURING METHOD AND METAL BELT

(71) Applicant: AISIN AW CO., LTD., Anjo-shi, Aichi-ken (JP)

(72) Inventors: Hiroyuki OHATA, Nishio (JP); Yohei ITO, Nagoya (JP)

(73) Assignee: AISIN AW CO., LTD., Anjo-shi, Aichi-ken (JP)

(21) Appl. No.: 16/074,189

(22) PCT Filed: Mar. 29, 2017
(86) PCT No.: PCT/JP2017/012860

§ 371 Date: Jul. 31, 2018

(30) Foreign Application Priority Data
Mar. 31, 2016 (JP) 2016-070767

(51) Int. Cl. F16G 5/16

(52) U.S. Cl. CPC F16G 5/16

(57) ABSTRACT

A metal belt manufacturing method includes: a step of inserting a retention member (30, 130) in an ended band shape into a clearance between an outer peripheral surface (12) of a ring (10) and an inner surface of a visor portion (23) which faces a base portion (21) in a recessed portion (25) and disposing the retention member (30, 130) circumferentially along the outer peripheral surface (12) of the ring (10); and a step of coupling the starting end portion and the terminal end portion of the retention member (30, 130) in an ended band shape to each other.

### CROSS REFERENCE TO RELATED APPLICATIONS

This application is a National Stage of International Application No. PCT/JP2017/012860, filed Mar. 29, 2017, claiming priority based on Japanese Patent Application No. 2016-070767, filed Mar. 31, 2016.

### TECHNICAL FIELD

Aspects of the application relate to a metal belt manufacturing method and a metal belt.

### BACKGROUND ART

There has hitherto been known a metal belt that includes a ring in an endless annular shape and a plurality of elements arranged circumferentially along the ring. Such a metal belt is disclosed in Japanese Patent Application Publication No. 2001-193796 (JP 2001-193796 A), for example.

JP 2001-193796 A discloses a metal belt that is wound around a drive pulley and a driven pulley to transfer power of the drive pulley to the driven pulley. The metal belt includes a band (ring) made of metal in an endless annular shape, a plurality of elements made of metal and each including a recessed portion that holds the band, and a slip-off prevention body (retention member) made of metal in an endless band shape that prevents the band from slipping out of the recessed portions of the elements. The metal belt is formed, in the cross-sectional structure, such that the width of the slip-off prevention body is larger than the width of the band. The metal belt is configured such that the slip-off prevention body covers the outer peripheral surface of the band and that both edge portions of the slip-off prevention body are retained by visor portions of the recessed portions when the band is mounted in the recessed portions. Accordingly, the band does not slip out of the recessed portions of the elements. In addition, the slip-off prevention body has a long hole that penetrates in the thickness direction and that extends over a predetermined distance in the longitudinal direction. Thus, a process of manufacturing the metal belt includes placing the slip-off prevention body along the outer peripheral surface of the band (ring), locally reducing the width of a section of the slip-off prevention body in which the long hole is formed, and fitting the narrowed portion of the slip-off prevention body in the recessed portions of the elements. The slip-off prevention body is configured such that, after the slip-off prevention body is narrowed and inserted into the recessed portions, the original width of the slip-off prevention body is restored in the recessed portions so that both edge portions of the slip-off prevention body are retained by the visor portions of the recessed portions.

### RELATED ART DOCUMENTS

### Patent Documents

Patent Document 1: Japanese Patent Application Publication No. 2001-193796 (JP 2001-193796 A)

### SUMMARY OF THE EMBODIMENTS

### Problem to be Solved by the Various Embodiments

In the process of manufacturing the metal belt described in JP 2001-193796 A, however, it is necessary to fit one or two of the elements at a time on the band and feed the elements forward while locally reducing the width of a section of the slip-off prevention body (retention member) in which the long hole is provided, and therefore a large number of elements cannot be assembled to the band. Therefore, it takes much assembly work time before all the elements are assembled to complete an annular metal belt.

In view of addressing the foregoing issue, it is an aspect to provide a metal belt manufacturing method and a metal belt that make it possible to shorten the assembly work time.

### Means for Solving the Problem

In order to achieve the foregoing aspects, a first aspect of the present application provides a metal belt manufacturing method including: a step of fitting elements for a metal belt sequentially on a ring in an endless annular shape and arranging the elements along the ring, the elements each having a recessed portion that holds the ring and that is constituted from a base portion, a visor portion, and a connection portion that connects between the base portion and the visor portion; a step of inserting a retention member in an ended band shape into a clearance between an outer peripheral surface of the ring and an inner surface of the visor portion which faces the base portion in the recessed portion with the plurality of elements arranged on the ring, and disposing the retention member circumferentially along the outer peripheral surface of the ring, the retention member preventing the ring from slipping out of the recessed portions of the elements; and a step of coupling a starting end portion and a terminal end portion of the retention member in an ended band shape to each other.

As described above, the metal belt manufacturing method according to the first aspect includes: the step of inserting the retention member in an ended band shape into the clearance between the outer peripheral surface of the ring and the inner surface of the visor portion which faces the base portion in the recessed portion, with the plurality of elements arranged on the ring, and disposing the retention member circumferentially along the outer peripheral surface of the ring, the retention member preventing the ring from slipping out of the recessed portion; and the step of coupling the starting end portion and the terminal end portion of the retention member in an ended band shape to each other. Consequently, a metal belt can be completed by inserting the retention member in an ended band shape into the clearance between the outer peripheral surface of the ring and the inner surface of the visor portion which faces the base portion in the recessed portion with a large number of elements arranged (aligned) on the ring in advance, winding the retention member circumferentially once, and thereafter coupling the starting end portion and the terminal end portion of the retention member to each other. Thus, most of the elements which constitute the single metal belt can be assembled to the ring in a short time, and thus the assembly work time during manufacture of the metal belt can be shortened. Since the single metal belt can be manufactured in a shorter time, in addition, a metal belt manufacturing method that makes it possible to improve the production efficiency can be provided.

A second aspect of the present application provides a metal belt including: a ring in an endless annular shape; a plurality of elements that each include a recessed portion that holds the ring; and a retention member in an ended band shape that has a starting end portion and a terminal end portion coupled to each other and that is disposed circumferentially along an outer peripheral surface of the ring with the plurality of elements arranged on the ring, the retention member preventing the ring from slipping out of the recessed portions of the elements.

As described above, the metal belt according to the second aspect includes the retention member in an ended band shape that has the starting end portion and the terminal end portion coupled to each other and that is disposed circumferentially along the outer peripheral surface of the ring with the plurality of elements arranged on the ring, the retention member preventing the ring from slipping out of the recessed portions of the elements. Consequently, a metal belt can be completed by inserting the retention member in an ended band shape into the clearance between the outer peripheral surface of the ring and the inner surface of the recessed portion (inner surface of the visor portion which faces the base portion in the recessed portion) with a large number of elements arranged on the ring in advance, winding the retention member circumferentially once, and thereafter coupling the starting end portion and the terminal end portion of the retention member to each other. Thus, most of the elements which constitute the single metal belt can be assembled to the ring in a short time, and thus the assembly work time during manufacture of the metal belt can be shortened. Since the single metal belt can be manufactured in a shorter time, in addition, a metal belt that makes it possible to improve the production efficiency can be provided.

With the present aspects, as described above, the assembly work time during manufacture of the metal belt can be shortened.

### BRIEF DESCRIPTION OF THE DRAWINGS

FIG. 1 illustrates the overall configuration of a metal belt manufactured using a manufacturing method according to a first embodiment of the present application.

FIG. 2 is a cross-sectional view of the metal belt illustrated in FIG. 1 taken along the line 150-150.

FIG. 3 is a cross-sectional view of the metal belt illustrated in FIG. 1 taken along the line 160-160.

FIG. 4 is a development view of a retainer that constitutes the metal belt manufactured using the manufacturing method according to the first embodiment of the present application.

FIG. 5 illustrates the detailed configuration of the metal belt manufactured using the manufacturing method according to the first embodiment of the present application.

FIG. 6 illustrates a process of manufacturing the metal belt according to the first embodiment of the present application.

FIG. 7 illustrates a process of manufacturing the metal belt according to the first embodiment of the present application.

FIG. 8 illustrates a process of manufacturing the metal belt according to the first embodiment of the present application.

FIG. 9 illustrates a process of manufacturing the metal belt according to the first embodiment of the present application.

FIG. 10 illustrates a process of manufacturing the metal belt according to the first embodiment of the present application.

FIG. 11 illustrates a process of manufacturing the metal belt according to the first embodiment of the present application.

FIG. 12 illustrates the detailed configuration of a metal belt manufactured using a manufacturing method according to a first modification of the first embodiment of the present application.

FIG. 13 illustrates the detailed configuration of a metal belt manufactured using a manufacturing method according to a second modification of the first embodiment of the present application.

FIG. 14 illustrates the detailed configuration of a metal belt manufactured using a manufacturing method according to a second embodiment of the present application.

FIG. 15 illustrates the detailed configuration of a metal belt manufactured using a manufacturing method according to a third embodiment of the present application.

FIG. 16 illustrates a process of manufacturing a metal belt according to a modification of the present application.

FIG. 17 illustrates a process of manufacturing the metal belt according to the modification of the present application.

### MODES FOR CARRYING OUT THE VARIOUS ASPECTS

Embodiments of the present application will be described below with reference to the drawings.

### First Embodiment

First, the configuration of a metal belt 100 according to a first embodiment will be described with reference to FIGS. 1 to 5.

(Configuration of Metal Belt)

As illustrated in FIG. 1, the metal belt 100 which is manufactured using a manufacturing method according to the first embodiment of the present invention includes a ring 10, a plurality of elements 20, and a retainer 30. The metal belt 100 is a mechanical element part that is wound around a drive (input shaft) pulley (not illustrated) and a driven (output shaft) pulley (not illustrated) of a belt-type continuously variable transmission (CVT) mounted on a vehicle (not illustrated) and that serves to transfer power between such pulleys. In FIG. 1, for convenience of illustration, the elements 20 in a certain section are indicated by the broken line, and the structure of the ring 10 and the coupling structure of the retainer 30 to be discussed later, which are incorporated inside such elements 20, are indicated by the solid line.

As illustrated in FIGS. 2 and 3, the ring 10 includes a plurality of thin metal plates 10a in an endless annular shape stacked on each other in the plate thickness direction (Z-axis direction). The elements 20 are made of metal, and each include a recessed portion 25 formed on the outer peripheral side (outer side in the radial direction of rotation of the metal belt 100) to hold (accommodate) the stacked ring 10. The elements 20 are configured to each have: a base portion 21 that has a bottom portion 22 that holds the ring 10 in the recessed portion 25; a pair of visor portions 23 that prevent the retainer 30 from being disengaged from the recessed portion 25 when the ring 10 and the retainer 30 are assembled to each other; and connection portions 24 that connect between the base portion 21 and the visor portions 23. An inner surface 25a in a recessed shape in the recessed portion 25 is constituted from the bottom portion 22, the connection portions 24, and the visor portions 23. The retainer 30 is provided in a clearance S between an outer peripheral surface 12 of the ring 10 (thin metal plate 10a in the outermost layer) and lower surfaces 23a (on the arrow Z2 side) of the pair of visor portions 23, of the inner surface 25a in a recessed shape. In this state, as illustrated in FIG. 1, the retainer 30 is disposed circumferentially (in a track shape) along the outer peripheral surface 12 on the outer side in the radial direction of rotation of the ring 10. The lower surfaces 23a are an example of the “inner surface of the visor portion which faces the base portion in the recessed portion” in the claims.

A pair of outer side surfaces 26 extending from the connection portions 24 to the visor portions 23 are to be fitted with a V-shaped groove (sliding surfaces) of each of the drive pulley and the driven pulley (not illustrated) to make surface contact. The retainer 30 is made of metal (maraging steel), and serves to prevent the ring 10 from slipping out of the recessed portions 25 of the elements 20 toward the outer side in the radial direction of rotation of the metal belt 100. The retainer 30 is an example of the “retention member in an ended band shape” in the claims.

In the first embodiment, as illustrated in FIG. 4, the retainer 30 is formed in an ended band shape for convenience of the process of manufacturing the metal belt 100. That is, the retainer 30 has, in a singular state, a first end portion 31, a second end portion 32, and a body portion 33 that connects between the first end portion 31 and the second end portion 32. The first end portion 31 has a pair of distal end portions 31a and 31b that extend in the X-axis direction in parallel with each other and that are bifurcated (symmetrically) in the width direction (Y-axis direction) with a center line (not illustrated) of the body portion 33 that extends along the X-axis direction serving as the axis of symmetry. That is, a notch portion 31c notched in a U-shape is provided at a portion at which the distal end portion 31a on the Y2 side and the distal end portion 31b on the Y1 side face each other in the width direction. A hole portion 31d that penetrates in the thickness direction (Z-axis direction) is formed in each of the distal end portions 31a and 31b. The second end portion 32 has one distal end portion 32a that extends along the center axis of the body portion 33 (not illustrated) and that is formed to have a width W2 that is smaller than that of the body portion 33. The width W2 of the distal end portion 32a is slightly smaller than a width W1 of the notch portion 31c at the first end portion 31. The body portion 33 has a constant width W3 from a boundary portion with the first end portion 31 to a boundary portion with the second end portion 32. The first end portion 31 and the second end portion 32 are an example of the “starting end portion” and the “terminal end portion”, respectively, in the claims.

In the metal belt 100 after being manufactured, as illustrated in FIG. 5, the first end portion 31 and the second end portion 32 of the retainer 30 are coupled (welded) to each other via a plate-like member 35 with the plurality of elements 20 disposed circumferentially along an inner peripheral surface 11 of the ring 10 (thin metal plate 10a in the innermost layer).

(Metal Belt Manufacturing Method)

Next, the process of manufacturing the metal belt 100 according to the first embodiment of the present application will be described with reference to FIGS. 1, 2, and 5 to 11.

<Step of Arranging Elements>

First, as illustrated in FIG. 6, the ring 10 in an endless annular shape is wound around a pair of shape holding rollers 80a and 80b, and the shape holding rollers 80a and 80b are spaced a predetermined distance away from each other in the X-axis direction so that the ring 10 is formed in a track shape (long circle shape). A plurality of elements 20 then are arranged on the ring 10 in a track shape. Specifically, the recessed portions 25 of the elements 20 are fitted on the inner peripheral surface 11 of the ring 10 from the inner side (the inner peripheral surface 11 side) of the ring 10.

In this event, in the first embodiment, the plurality of elements 20 are not arranged in a section A, and the elements 20 are arranged in most of the other section B. The spacing between the shape holding rollers 80a and 80b in the X-axis direction is adjusted appropriately so that the lower surfaces 21a, which are on the inner side in the radial direction of rotation, of the base portions 21 of the elements 20 contact outer surfaces 80c of the shape holding rollers 80a and 80b with the plurality of elements 20 arranged (aligned). Consequently, the individual elements 20 are arranged appropriately, and held sequentially one by one in a row as illustrated in FIG. 6. Consequently, in addition, the ring 10 is disposed (accommodated) in the recessed portions 25 of the elements 20 as illustrated in FIG. 7. The clearance S is formed between both end portions, in the width direction (Y-axis direction), of the outer peripheral surface 12 of the ring 10 and the lower surfaces 23a of the visor portions 23 which face the base portion 21 in the recessed portion 25. The clearance S extends continuously over the section B along a direction (X-axis direction) in which the elements 20 are arranged. The section A is an example of the “partial section” in the claims.

After that, as illustrated in FIG. 8, the distal end portions 31a and 31b, which are formed at the first end portion 31 of the retainer 30 formed in a reed shape (long and thin shape), are brought closer to each other to reduce the width of the first end portion 31. In this event, an assembly worker (not illustrated) inserts a pair of end portions 90a and 90b of a hook member 90, which is formed in a U-shape in advance, into the pair of hole portions 31d, which are formed in the distal end portions 31a and 31b in advance. Consequently, the width 4 of the first end portion 31 is reduced by correcting the shape of the first end portion 31 such that the distal end portion 31a and the distal end portion 31b are brought closer to each other. That is, the width of the first end portion 31, which is the width W3 at the root portion (X2 side) of the first end portion 31, is decreased to a width W4 (W4<W3).

The approaching distance between the distal end portion 31a and the distal end portion 31b is adjusted to such a distance that the thickness (outer shape), in the Z direction, of the first end portion 31 is not significantly increased because of bending deformation of the metal material around the notch portion 31c (root portions of the distal end portions 31a and 31b). The width W4 is smaller than a separation interval W5, in the Y-axis direction, between the left and right visor portions 23 (see FIG. 7) of the element 20. In FIG. 8, the outer shape of the first end portion 31 before the width is reduced is indicated by the dash-double-dot line, and the outer shape of the distal end portions 31a and 31b after the hook member 90 is attached is indicated by the thick solid line. The hook member 90 is an example of the “shape holding member” in the claims.

<Step of Inserting Retainer>

After that, as illustrated in FIG. 9, the retainer 30 in an ended band shape is inserted into the clearance S between the outer peripheral surface 12 of the ring 10 and the lower surfaces 23a of the visor portions 23 which face the base portion 21 in the recessed portion 25 with the elements 20 arranged (aligned) on the ring 10. Specifically, feed rollers 81a and 81b and guide rollers 82 to 84 are set. The feed rollers 81a and 81b hold the retainer 30 and automatically feed the retainer 30 into the elements 20. The guide rollers 82 to 84 guide operation to feed the retainer 30 so that the retainer 30 is wound circumferentially once in the direction of the arrow X1 along the ring 10. The guide rollers 82 to 84 are each provided with a spring member 85 so that the guide rollers 82 to 84, which are rotated themselves, press the outer peripheral surface 12 of the ring 10 with a predetermined pressing force.

The first end portion 31, the width of which has been reduced, is inserted into the clearance S with the retainer 30 in a thin plate shape held between the feed rollers 81a and 81b. In this event, in the first embodiment, the first end portion 31 of the retainer 30 in an ended band shape is inserted into the clearance S (see FIG. 7) along the direction of the arrow J1 (X1), with the plurality of elements 20 not arranged in the section A of the ring 10, using a first element 20a that is adjacent to the section A as the start point. The retainer 30 is circulated in the clearance S (see FIG. 7), which extends in a track shape, with the first end portion 31 serving as the leading end as the feed rollers 81a and 81b are rotationally driven. That is, the retainer 30 is caused to immediately pass through the inside (clearance S) of the elements 20 corresponding to the section B (see FIG. 6). The length of the section A (the number of elements 20b (see FIG. 11) that are not attached in the step of inserting the retainer) is preferably as short as possible, as long as it is possible to feed the retainer 30 into the clearance S from the element 20a which is adjacent to the section A. Consequently, the time required to assemble the elements 20b (see FIG. 11) prior to a coupling step to be discussed later is shortened.

The hook member 90 (see FIG. 8) is attached to the distal end of the first end portion 31, and slightly projects in the thickness direction. However, the expansion/contraction function of the spring member 85 which is provided to each of the guide rollers 82 to 84 makes it easy for the distal end of the first end portion 31 to pass between the guide rollers 82 to 84 and the outer peripheral surface 12 of the ring 10. The feed rollers 81a and 81b are constituted as a single movable unit 81c. Consequently, the movable unit 81c is configured to be moved to the vicinity of the section A along the direction of the arrow J1 when the retainer 30 is wound generally once and a portion of the retainer 30 held by the feed rollers 81a and 81b becomes closer to the second end portion 32. The second end portion 32 is fed out from the feed rollers 81a and 81b to be placed on the outer peripheral surface 12 of the ring 10. In this way, the retainer 30 is disposed circumferentially along the outer peripheral surface 12 of the ring 10.

<Step of Coupling Retainer>

After that, as illustrated in FIG. 10, the first end portion 31 and the second end portion 32 of the retainer 30, which is disposed circumferentially along the outer peripheral surface 12 of the ring 10, are positioned in the section A. As illustrated in FIG. 11, the remaining elements 20b are assembled to a portion of the first end portion 31 and the second end portion 32 which is positioned in the section A and the width of which has been reduced. After that, the width of the first end portion 31, which has been reduced to W4, is returned to the original state (state with the width W3), in which the width is not reduced, by removing the hook member 90 from the pair of hole portions 31d as illustrated in FIG. 5 from the state in which the hook member 90 is temporarily fastened to the pair of hole portions 31d as illustrated in FIG. 10.

In this state, the plate-like member 35 is placed to cover the upper surfaces (to the front side of the drawing sheet surface) of the first end portion 31 and the second end portion 32. The first end portion 31 and the plate-like member 35 then are welded to each other on welding lines P (at three locations) in a streak shape, and the second end portion 32 and the plate-like member 35 are welded to each other on welding lines P (at three locations), via the plate-like member 35. Consequently, the first end portion 31 and the second end portion 32 are coupled to each other. In this way, the retainer 30 in an annular shape (endless annular shape) is fixed in the recessed portion 25 along the outer peripheral surface 12 of the ring 10. Finally, the movable unit 81c, the guide rollers 82 to 84, and the shape holding rollers 80a and 80b (see FIG. 9) are removed to complete manufacture of the metal belt 100 (see FIG. 1).

### Effects of Metal Belt Manufacturing Method According to First Embodiment

The following effects can be obtained with the first embodiment.

As described above, the process of manufacturing the metal belt 100 according to the first embodiment includes: a step of inserting the retainer 30 in an ended band shape into the clearance S between the outer peripheral surface 12 of the ring 10 and the lower surfaces 23a of the visor portions 23 which face the base portion 21 in the recessed portions 25 of the elements 20, with the plurality of elements 20 arranged on the ring 10, and disposing the retainer 30 circumferentially along the outer peripheral surface 12 of the ring 10, the retainer 30 preventing the ring 10 from slipping out of the recessed portions 25; and a step of coupling the first end portion 31 and the second end portion 32 of the retainer 30 in an ended band shape to each other. Consequently, the metal belt 100 can be completed by inserting the retainer 30 in an ended band shape into the clearance S between the outer peripheral surface 12 of the ring 10 and the lower surfaces 23a of the visor portions 23 which face the base portion 21 in the recessed portions 25 with a large number of elements 20 arranged (aligned) on the ring 10 in advance, winding the retainer 30 circumferentially once, and thereafter coupling the first end portion 31 and the second end portion 32 of the retainer 30 to each other. Thus, most of the elements 20 which constitute the single metal belt 100 can be assembled to the ring 10 in a short time, and thus the assembly work time (lead time) during manufacture of the metal belt 100 can be shortened. Shortening of the time required for manufacture (lead time) contributes to a reduction in the load on the assembly worker. In addition, the single metal belt 100 can be manufactured in a shorter time. Thus, a method of manufacturing the metal belt 100 that makes it possible to improve the production efficiency can be provided.

In the first embodiment, in addition, the single metal belt 100 can be manufactured in a shorter time through application of the manufacturing process described above. Thus, the production efficiency for the metal belt 100 can be improved. That is, the production schedule for the metal belt 100 can be flexibly adapted to the demand to produce belt-type continuously variable transmissions (CVTs).

In the process of manufacturing the metal belt 100 according to the first embodiment, in addition, the step of inserting the retainer 30 in an ended band shape into the clearance S and disposing the retainer 30 circumferentially along the outer peripheral surface 12 of the ring 10 is configured to include a step of inserting the first end portion 31 of the retainer 30, the width of which has been reduced, into the clearance S and disposing the first end portion 31 circumferentially along the outer peripheral surface 12 of the ring 10. Consequently, the first end portion 31, the width of which has been reduced (state with the width W4), can be smoothly inserted into the clearance S between the outer peripheral surface 12 of the ring 10 and the lower surfaces 23a of the visor portions 23 which face the base portion 21 in the recessed portions 25. Thus, the retainer 30 can be circulated easily and in a short time in the clearance S which is formed in a track shape, with the first end portion 31 of the retainer 30 serving as the leading end in the feeding direction.

In the process of manufacturing the metal belt 100 according to the first embodiment, in addition, the step of inserting the first end portion 31 into the clearance S and disposing the first end portion 31 circumferentially along the outer peripheral surface 12 of the ring 10 is configured to include a step of inserting the first end portion 31 into the clearance S with the width of the first end portion 31 reduced by bringing the pair of hole portions 31d, which are formed near the distal end portion 31a (31b) of the first end portion 31 in advance, closer to each other using the hook member 90. Consequently, the entire retainer 30 can be circulated easily and in a short time along the clearance S which is formed in a track shape while the hook member 90 is maintaining a state in which the distal end portion of the first end portion 31 is narrowed easily using the hook member 90.

In the process of manufacturing the metal belt 100 according to the first embodiment, in addition, the step of inserting the retainer 30 in an ended band shape into the clearance S and disposing the retainer 30 circumferentially along the outer peripheral surface 12 of the ring 10 is configured to include a step of inserting the first end portion 31 of the retainer 30 in an ended band shape into the clearance S, with the plurality of elements 20 not arranged in the section A of the ring 10, using the element 20a which is adjacent to the section A as the start point. Consequently, the entire retainer 30 can be circulated in a short time in the clearance S which extends continuously in a track shape in the section B other than the section A with a large number of elements 20 corresponding to the section B arranged (aligned) on the ring 10 in advance.

In addition, the process of manufacturing the metal belt 100 according to the first embodiment further includes a step of assembling the remaining elements 20b (see FIG. 11) to the section A, in which the elements 20 are not arranged, after the retainer 30 in an ended band shape is inserted into the clearance S and disposed circumferentially along the outer peripheral surface 12 of the ring 10. Consequently, the metal belt 100 in a complete track shape (annular shape) can be formed easily by just assembling a small number of elements 20b (see FIG. 11) corresponding to the section A compared to the elements 20 which are arranged in the section B in advance.

In the process of manufacturing the metal belt 100 according to the first embodiment, in addition, the step of assembling the remaining elements 20 to the section A is configured to include a step of positioning the first end portion 31 and the second end portion 32 of the retainer 30, which is disposed circumferentially along the outer peripheral surface 12 of the ring 10, in the section A and assembling the remaining elements 20b (see FIG. 11) to the first end portion 31 and the second end portion 32, the width of which has been reduced. Consequently, the recessed portions 25 of the remaining elements 20b (see FIG. 11) can be easily fitted on the inner peripheral surface 11 of the ring 10 from the inner side (the inner peripheral surface 11 side) of the ring 10 with the first end portion 31 (width W4) and the second end portion 32 (width W2), the width of which has been reduced to be smaller than the width W3 of the body portion 33, positioned in the section A in which the elements 20 are not provided.

In the process of manufacturing the metal belt 100 according to the first embodiment, in addition, the step of coupling the first end portion 31 and the second end portion 32 of the retainer 30 to each other is configured to include a step of coupling the first end portion 31 and the second end portion 32 to each other at a position corresponding to the section A in which the remaining elements 20b (see FIG. 11) are assembled. Consequently, the retainer 30 can be immediately formed into an endless shape (annular shape with no end portion) with the metal belt 100 in a complete track shape obtained by assembling the elements 20b to the section A.

In the process of manufacturing the metal belt 100 according to the first embodiment, in addition, the step of coupling the first end portion 31 and the second end portion 32 to each other in the section A is configured to include a step of coupling the first end portion 31 and the second end portion 32 to each other with the width of the first end portion 31, which has been reduced to W4, returned to a state in which the width is not reduced (width W3). Consequently, the first end portion 31 and the second end portion 32 can be reliably coupled to each other with both end portions (the first end portion 31 and the second end portion 32), in the width direction (Y-axis direction), of the retainer 30 reliably disposed in the clearance S (see FIG. 3) between both end portions, in the width direction (Y-axis direction), of the outer peripheral surface 12 of the ring 10 and the lower surfaces 23a of the visor portions 23 which face the base portion 21 in the recessed portions 25 (in a state in which the first end portion 31 and the second end portion 32 do not overlap each other in the thickness direction) also in the section A.

In the process of manufacturing the metal belt 100 according to the first embodiment, in addition, the step of coupling the first end portion 31 and the second end portion 32 of the retainer 30 to each other is configured to include a step of coupling the first end portion 31 and the second end portion 32 to each other by welding via the plate-like member 35 which covers the first end portion 31 and the second end portion 32 which face each other. Consequently, the first end portion 31 and the second end portion 32 can be coupled to each other via the plate-like member 35 by coupling the first end portion 31 and the plate-like member 35 to each other by welding and coupling the second end portion 32 and the plate-like member 35 to each other by welding. Thus, the coupling strength between the first end portion 31 and the second end portion 32 can be secured. In addition, damage to the ring 10 due to the welding can be suppressed as much as possible because the plate-like member 35 is interposed.

### First Modification of First Embodiment

Next, a first modification of the first embodiment will be described with reference to FIGS. 4 and 12. In the first modification of the first embodiment, a metal belt 110 is manufactured using a retainer 130 that has a first end portion 131 and a second end portion 132 shaped differently from the end portions according to the first embodiment described above. The first end portion 131 and the second end portion 132 are an example of the “starting end portion” and the “terminal end portion”, respectively, in the claims. In addition, the retainer 130 is an example of the “retention member in an ended band shape” in the claims. In the drawings, components that are similar to those according to the first embodiment described above are given the same reference numerals for illustration.

In a manufacturing process according to the first modification of the first embodiment, as illustrated in FIG. 12, the metal belt 110 is manufactured using the retainer 130 which has the first end portion 131 and the second end portion 132. That is, the retainer 130 is provided, in advance, with: the first end portion 131 which has distal end portions 131a and 131b left on both sides of a notch portion 131c notched in a shape (valley shape) that is similar to a keyhole; and the second end portion 132 which is formed in a tapered shape (mountain shape) in which the width of a distal end portion 132a is reduced so as to correspond to the shape of the notch portion 131c. The distal end portions 131a and 131b and the foremost portion of the second end portion 132 are chamfered so as not to be completely pointed.

In a manufacturing process that is similar to the process of manufacturing the metal belt 100 according to the first embodiment described above, the retainer 130 is wound circumferentially once in the clearance S which extends in a track shape (disposed circumferentially on the ring 10), with the first end portion 131 of the retainer 130 having a reduced width serving as the leading end. Facing portions of the first end portion 131 in a valley shape and the second end portion 132 in a mountain shape are aligned with the section A, and the first end portion 131 and the plate-like member 35 are welded to each other on welding lines P (at three locations) in a streak shape, and the second end portion 132 and the plate-like member 35 are welded to each other on welding lines P (at three locations). Consequently, the first end portion 131 and the second end portion 132 are coupled to each other. The metal belt 110 is manufactured in this way.

### Effects of Metal Belt Manufacturing Method According to First Modification of First Embodiment

With the process of manufacturing the metal belt 110 according to the first modification of the first embodiment, the metal belt 110 can be manufactured in a shorter assembly work time also using the retainer 130 which is configured to have end portions in different mating shapes (facing shapes) from the end portions of the retainer 30 (see FIG. 4) according to the first embodiment described above. The other effects are the same as those according to the first embodiment described above.

### Second Modification of First Embodiment

Next, a second modification of the first embodiment will be described with reference to FIGS. 4, 7, and 13. In the second modification of the first embodiment, a metal belt 120 is manufactured using a retainer 230 that has a second end portion 232 shaped differently from that according to the first embodiment described above. The retainer 230 and the second end portion 232 are an example of the “retention member in an ended band shape” and the “terminal end portion”, respectively, in the claims. In the drawings, components that are similar to those according to the first embodiment described above are given the same reference numerals for illustration.

In a manufacturing process according to the second modification of the first embodiment, as illustrated in FIG. 13, the metal belt 120 is manufactured using the retainer 230 which has the first end portion 31 and the second end portion 232. That is, the retainer 230 is provided, in advance, with the first end portion 31 which has the distal end portions 31a and 31b on both sides of the notch portion 31c, and the second end portion 232 which does not have the distal end portion 32a (see FIG. 4). The retainer 230 is circulated in the clearance S (see FIG. 7) which extends in a track shape with the width of the first end portion 31 reduced and with the first end portion 31 serving as the leading end. After that, with the second end portion 232 facing the first end portion 31, the first end portion 31 and the plate-like member 35 are welded to each other in a partial section of a welding line Q in a frame shape, and the second end portion 232 and the plate-like member 35 are welded to each other in the other section of the welding line Q. Consequently, the first end portion 31 and the second end portion 232 are coupled to each other. The metal belt 120 is manufactured in this way. The step of inserting the retainer 230, in which the retainer 230 is inserted into the clearance S between the ring 10 and the recessed portions 25 and wound circumferentially once, is the same as that according to the first embodiment described above.

### Effects of Metal Belt Manufacturing Method According to Second Modification of First Embodiment

With the process of manufacturing the metal belt 120 according to the second modification of the first embodiment, the metal belt 120 can be manufactured in a shorter assembly work time also using the retainer 230 which is configured to have end portions in different mating shapes (facing shapes) from the end portions of the retainer 30 (see FIG. 4) according to the first embodiment described above. The other effects are the same as those according to the first embodiment described above.

### Second Embodiment

Next, a second embodiment will be described with reference to FIGS. 7, 8, 10, 11, and 14. In the second embodiment, unlike the first embodiment described above, a manufacturing process is applied in which the retainer 30 is inserted into the clearance S and wound circumferentially once with the second end portion 32 serving as the leading end and thereafter the second end portion 32 and the first end portion 31 are coupled to each other. In the second embodiment, the first end portion 31 and the second end portion 32 are an example of the “terminal end portion” and the “starting end portion”, respectively, in the claims. In the drawings, in addition, components that are similar to those according to the first embodiment described above are given the same reference numerals for illustration.

That is, in the process of manufacturing a metal belt 200 according to the second embodiment, in the step of inserting the retainer 30, as illustrated in FIG. 14, the second end portion 32 of the retainer 30 is inserted into the clearance S (see FIG. 7) along the direction of the arrow J1 (X1), and circulated once in the clearance S which extends in a track shape with the second end portion 32 serving as the leading end. Also in this case, the hook member 90 (see FIG. 8) is attached to the first end portion 31 to reduce the width thereof in advance. Then, with the second end portion 32 and the first end portion 31 of the retainer 30 positioned in the section A as in the case of FIG. 10, the remaining elements 20b are assembled to the section A as in the case of FIG. 11. The width of the first end portion 31, which has been reduced, is returned to a state in which the width is not reduced. After that, as illustrated in FIG. 14, the second end portion 32 and the plate-like member 35 are welded to each other on welding lines P (at three locations), and the first end portion 31 and the plate-like member 35 are welded to each other on welding lines P (at three locations), via the plate-like member 35. Consequently, the first end portion 31 and the second end portion 32 are coupled to each other. The process of manufacturing the metal belt 200 is otherwise the same as that according to the first embodiment described above.

### Effects of Metal Belt Manufacturing Method According to Second Embodiment

With the process of manufacturing the metal belt 200 according to the second embodiment, in which the direction of inserting the retainer 30 is opposite to that according to the first embodiment described above, the metal belt 200 can be manufactured in a shorter assembly work time. The other effects are the same as those according to the first embodiment described above.

### Third Embodiment

Next, a third embodiment will be described with reference to FIGS. 5, 11, and 15. In the third embodiment, a metal belt 300 is manufactured by directly coupling the first end portion 31 and the second end portion 32 of the retainer 30 to each other without using the plate-like member 35 (see FIG. 5). In the drawings, components that are similar to those according to the first embodiment described above are given the same reference numerals for illustration.

That is, in the process of manufacturing the metal belt 300 according to the third embodiment, as illustrated in FIG. 11, the remaining elements 20b are assembled to a portion of the first end portion 31 and the second end portion 32 which is positioned in the section A and the width of which has been reduced. The hook member 90 then is removed. After that, as illustrated in FIG. 15, respective peripheral edge portions 31e and 32e of the first end portion 31 and the second end portion 32 are directly welded to each other along a welding line R with the first end portion 31 and the second end portion 32 facing each other. The metal belt 300 is manufactured in this way. The process of manufacturing the metal belt 300 is otherwise the same as that according to the first embodiment described above.

### Effects of Metal Belt Manufacturing Method According to Third Embodiment

With the process of manufacturing the metal belt 300 according to the third embodiment, the coupling strength between the first end portion 31 and the second end portion 32 can be secured even without using the plate-like member 35 (see FIG. 5). Then, the metal belt 300 can be manufactured in a shorter assembly work time. The other effects are the same as those according to the first embodiment described above.

[Modifications]

The embodiments disclosed herein should be considered as exemplary and non-limiting in all respects. The scope of the present application is defined by the scope of the claims, rather than the description of the above embodiments, and includes all changes (modifications) that fall within the scope of the claims and the meaning and scope of equivalence.

For example, in the first to third embodiments described above, the width of the first end portion 31 is reduced by temporarily fastening the hook member 90 to the pair of hole portions 31d. However, the present application is not limited thereto. For example, a metal belt 400 may be manufactured by applying a manufacturing process according to a modification of the present embodiment illustrated in FIGS. 16 and 17. Specifically, as illustrated in FIG. 16, an assembly worker (not illustrated) uses pliers 91 to insert a pair of bent distal end portions 91a and 91b on a grasping portion side for grasping a part into a pair of hole portions 31d of the distal end portions 31a and 31b, respectively, of the first end portion 31. The width of the first end portion 31 then is reduced by squeezing handles 91c of the pliers 91 and bringing the distal end portion 31a and the distal end portion 31b closer to each other, so that the shape of the first end portion 31 is corrected. In a step of winding the retainer 30 circumferentially once around the outer peripheral surface 12 of the ring 10, as illustrated in FIG. 17, the assembly worker pulls the retainer 30, the width of the first end portion 31 of which has been reduced using the pliers 91, in the direction of the arrow X1 so that the retainer 30 is wound circumferentially once around the outer peripheral surface 12 of the ring 10. In this case, the movable unit 81c, the guide rollers 82 to 84, and the shape holding rollers 80a and 80b (see FIG. 9) illustrated in relation to the first embodiment described above are not necessary. The pliers 91 are an example of the “jig” in the claims.

Also with the configuration of the modification, the entire retainer 30 can be circulated easily and in a short time in the clearance S which is formed in a track shape while the pliers 91 are maintaining a state in which the distal end portion of the first end portion 31 is narrowed easily using the pliers 91. Thus, the metal belt 400 can be manufactured in a shorter time (lead time). In the modification, the pliers 91 which are used by the assembly worker are used as an example of the “jig”. However, the various aspects of present application are not limited thereto. That is, a mechanical device that automatically pinches the distal end portion of the first end portion 31 to reduce the width thereof may also be used.

In the first modification of the first embodiment described above, the second end portion 132 in a simple tapered shape (mountain shape) is caused to face the notch portion 131c in a keyhole shape to be coupled thereto. However, the present application is not limited thereto. The distal end portion 132a of the second end portion 132 may be formed in an arcuate shape that matches the keyhole shape of the notch portion 131c so as to be fitted in the notch portion 131c. Consequently, the retainer 130 in an annular shape before coupling (welding) can be easily prevented from becoming loose because the distal end portion 132a is caught by the notch portion 131c when the retainer 130 is wound once and the first end portion 131 and the second end portion 132 face each other.

In the first embodiment described above, the first modification of the first embodiment, and the second and third embodiments, in addition, the first end portion 31 (131) and the second end portion 32 (232) have mating shapes to be mated with each other. However, the present application is not limited thereto. For example, both end portions of a retainer (retention member in an ended band shape) may be formed in the same shape as that of the first end portion 31, and the retainer may be wound circumferentially once and the end portions which are formed in the same shape as each other may be caused to face each other to be coupled to each other via the plate-like member 35. Consequently, since the retainer is not directional as to insertion into the clearance S, the assembly worker does not have to give attention to the direction of insertion the retainer to manufacture uniform metal belts.

In the first to third embodiments described above and the modification of the various aspects of the present application described above, in addition, the aspects may be applied to the method of manufacturing the metal belts 100 to 400 for belt-type continuously variable transmissions (CVTs) mounted on a vehicle (not illustrated). However, the present application is not limited thereto. For example, the various aspects of the present application may be applied to a method of manufacturing a metal belt for power transfer devices other than the belt-type continuously variable transmissions to be mounted on a vehicle, as long as the power transfer devices are mechanical devices that are capable of transferring power with the metal belt wound around a drive pulley and a driven pulley.

### DESCRIPTION OF THE REFERENCE NUMERALS

10 RING (RING IN ENDLESS ANNULAR SHAPE)
11 INNER PERIPHERAL SURFACE
12 OUTER PERIPHERAL SURFACE
20 ELEMENT
21 BASE PORTION
23 VISOR PORTION
23a LOWER SURFACE (INNER SURFACE OF VISOR PORTION WHICH FACES BASE PORTION IN RECESSED PORTION)
24 CONNECTION PORTION
25 RECESSED PORTION
30, 130 RETAINER (RETENTION MEMBER IN ENDED BAND SHAPE)
31 FIRST END PORTION (STARTING END PORTION, TERMINAL END PORTION)
31a, 31b, 32a, 131a, 131b, 132a DISTAL END PORTION
31c, 131c NOTCH PORTION
31d HOLE PORTION
32 SECOND END PORTION (TERMINAL END PORTION, STARTING END PORTION)
33 BODY PORTION
35 PLATE-LIKE MEMBER
90 HOOK MEMBER (SHAPE HOLDING MEMBER)
91 PLIERS (JIG)
100, 110, 120, 130, 200, 300, 400 METAL BELT
131 FIRST END PORTION (STARTING END PORTION)
132, 232 SECOND END PORTION (TERMINAL END PORTION)
A SECTION (PARTIAL SECTION)
S CLEARANCE
P, Q, R WELDING LINE

1. A metal belt manufacturing method, comprising:
a step of fitting elements for a metal belt sequentially on a ring in an endless annular shape and arranging the elements along the ring, the elements each having a recessed portion that holds the ring and that is constituted from a base portion, a visor portion, and a connection portion that connects between the base portion and the visor portion;
a step of inserting a retention member in an ended band shape into a clearance between an outer peripheral surface of the ring and an inner surface of the visor portion which faces the base portion in the recessed portion with the plurality of elements arranged on the ring, and disposing the retention member circumferentially along the outer peripheral surface of the ring, the retention member preventing the ring from slipping out of the recessed portions of the elements; and
a step of coupling a starting end portion and a terminal end portion of the retention member in an ended band shape to each other.

2. The metal belt manufacturing method according to claim 1, wherein
the step of inserting the retention member in an ended band shape into the clearance and disposing the retention member circumferentially along the outer peripheral surface of the ring includes a step of inserting the starting end portion of the retention member in an ended band shape, a width of which has been reduced, into the clearance and disposing the starting end portion circumferentially along the outer peripheral surface of the ring.

3. The metal belt manufacturing method according to claim 2, wherein
the step of inserting the starting end portion into the clearance and disposing the starting end portion circumferentially along the outer peripheral surface of the ring includes a step of inserting the starting end portion into the clearance with the width of the starting end portion reduced by bringing a pair of hole portions, which are formed in advance near an end portion of the starting end portion, closer to each other using a jig or a shape holding member.

4. The metal belt manufacturing method according to claim 3, wherein
the step of inserting the retention member in an ended band shape into the clearance and disposing the retention member circumferentially along the outer peripheral surface of the ring further includes a step of inserting the starting end portion of the retention member in an ended band shape into the clearance, with the plurality of elements not arranged in a partial section of the ring, using the element which is adjacent to the partial section as a start point.

5. The metal belt manufacturing method according to claim 4, further comprising:
a step of assembling remaining elements to the partial section, in which the elements are not arranged, after the retention member in an ended band shape is inserted into the clearance and disposed circumferentially along the outer peripheral surface of the ring.

6. The metal belt manufacturing method according to claim 5, wherein
the step of assembling the remaining elements to the partial section includes a step of positioning the starting end portion and the terminal end portion of the retention member in an ended band shape, which is disposed circumferentially along the outer peripheral surface of the ring, in the partial section and assembling the remaining elements to the starting end portion or the terminal end portion, a width of which has been reduced.

7. The metal belt manufacturing method according to claim 6, wherein
the step of coupling the starting end portion and the terminal end portion of the retention member in an ended band shape to each other includes a step of coupling the starting end portion and the terminal end portion to each other at a position corresponding to the partial section in which the remaining elements are assembled.

8. The metal belt manufacturing method according to claim 7, wherein
the step of coupling the starting end portion and the terminal end portion to each other in the partial section includes a step of coupling the starting end portion and the terminal end portion to each other after a width of one of the starting end portion and the terminal end portion, which has been reduced, is returned to a state in which the width is not reduced.

9. The metal belt manufacturing method according to claim 8, wherein
the step of coupling the starting end portion and the terminal end portion of the retention member in an ended band shape to each other includes a step of coupling the starting end portion and the terminal end portion to each other by either directly welding the starting end portion and the terminal end portion, which face each other, together, or welding the starting end portion and the terminal end portion together via a plate-like member that covers the starting end portion and the terminal end portion which face each other.

10. A metal belt comprising:
a ring in an endless annular shape;
a plurality of elements that each include a recessed portion that holds the ring; and
a retention member in an ended band shape that has a starting end portion and a terminal end portion coupled to each other and that is disposed circumferentially along an outer peripheral surface of the ring with the plurality of elements arranged on the ring, the retention member preventing the ring from slipping out of the recessed portions of the elements.

11. The metal belt manufacturing method according to claim 1, wherein
the step of inserting the retention member in an ended band shape into the clearance and disposing the retention member circumferentially along the outer peripheral surface of the ring further includes a step of inserting the starting end portion of the retention member in an ended band shape into the clearance, with the plurality of elements not arranged in a partial section of the ring, using the element which is adjacent to the partial section as a start point.

12. The metal belt manufacturing method according to claim 11, further comprising:
a step of assembling remaining elements to the partial section, in which the elements are not arranged, after the retention member in an ended band shape is inserted into the clearance and disposed circumferentially along the outer peripheral surface of the ring.

13. The metal belt manufacturing method according to claim 12, wherein
the step of assembling the remaining elements to the partial section includes a step of positioning the starting end portion and the terminal end portion of the retention member in an ended band shape, which is disposed circumferentially along the outer peripheral surface of the ring, in the partial section and assembling the remaining elements to the starting end portion or the terminal end portion, a width of which has been reduced.

14. The metal belt manufacturing method according to claim 13, wherein
the step of coupling the starting end portion and the terminal end portion of the retention member in an ended band shape to each other includes a step of coupling the starting end portion and the terminal end portion to each other at a position corresponding to the partial section in which the remaining elements are assembled.

15. The metal belt manufacturing method according to claim 14, wherein
the step of coupling the starting end portion and the terminal end portion to each other in the partial section includes a step of coupling the starting end portion and the terminal end portion to each other after a width of one of the starting end portion and the terminal end portion, which has been reduced, is returned to a state in which the width is not reduced.

16. The metal belt manufacturing method according to claim 15, wherein
the step of coupling the starting end portion and the terminal end portion of the retention member in an ended band shape to each other includes a step of coupling the starting end portion and the terminal end portion to each other by either directly welding the starting end portion and the terminal end portion, which face each other, together, or welding the starting end portion and the terminal end portion together via a plate-like member that covers the starting end portion and the terminal end portion which face each other.
